(19) United States
(12) Patent Application Publication
(10) Pub. No.: US 2006/0185610 A1
(43) Pub. Date: Aug. 24, 2006

(54) Aquatic deck structure

(76) Inventor: Wilbur Canady JR., Cincinnati, OH (US)

Correspondence Address: Mark F. Smith, 905 Ohio Pike, Cincinnati, OH, 45245, US

(21) Appl. No.: 11/054,480

(22) Filed: Feb. 9, 2005

(51) Int. Cl. A01K 63/00

(52) U.S. Cl. 119/253

(57) ABSTRACT

The present invention is an aquatic deck structure for use in an aquarium. In a preferred embodiment of the invention, the aquatic deck structure is constructed such that it displaces sufficient water to float in water and includes a body comprising an inner core formed from a buoyant material encased within an outer wall formed from concrete.

### BACKGROUND OF THE INVENTION

The present invention relates to aquariums and more particularly to an aquatic deck structure for use in aquariums.

Various types of aquatic structures and devices are available for use in aquariums. Such structures and devices include artificial plants, underwater sculptures, artificial rock and log formations, filtration and aeration apparatus and other similar structures and devices. In addition, scenic views attached to the outside glass of an aquarium to form natural backgrounds are also available to enhance the appearance of the aquarium. For providing an attractive scenic appearance, some of the structures are constructed such that a portion of the structure will extend out of the water and may be used as a resting place for reptiles such as turtles or amphibians such as frogs. Unfortunately, these structures are often relatively large making them generally undesirable for use in small aquariums. Further, many of the structures that extend above the surface of the water are difficult or impossible for certain marine creatures to climb onto. This is particularly true when the water level inside the aquarium drops, such as by evaporation, below a desired level.

Accordingly, it would be desirable to have an aquatic deck structure for use in an aquarium that permits marine creatures to easily climb onto a deck structure, which can be used effectively for both large and small aquariums, and enhances the scenic appearance within the aquarium. It would also be desirable for the aquatic deck structure that is relatively inexpensive to manufacture.

### SUMMARY OF THE INVENTION

The present invention is an aquatic deck structure for use in an aquarium. In a preferred embodiment of the invention the aquatic deck structure is constructed such that it displaces sufficient water to float in water and includes a body comprising an inner core formed from a buoyant material encased within an outer wall formed from concrete. The body further comprises a deck and is contoured such that at least a portion of the deck is at or below the surface of the water.

In another preferred embodiment of the invention, the aquatic deck structure is shaped to simulate the appearance of an island.

In another preferred embodiment of the invention, the aquatic deck structure is shaped to simulate a natural aquatic structure such as a rock or log formation, leaves, an island, water plants, and the like.

In another preferred embodiment of the invention, the deck includes ridges effective for improving the traction of a marine creature.

In another preferred embodiment of the invention, the aquatic deck structure is weighted to allow a portion of the deck to be maintained at or below the level of the water.

In another preferred embodiment of the invention, the aquatic deck structure includes an anchoring means for securing the structure in place on the surface of the water.

Another embodiment of the invention is a method of manufacturing an aquatic deck structure comprising the steps of coating a base board with a non-stick material; placing side boards onto the base board; and forming a body by pouring concrete onto the base board to a desired thickness; placing a buoyant material onto the base board; and pouring concrete over the buoyant material encase the buoyant material within an outer wall of a desired thickness.

In another preferred embodiment of the invention, the method further comprises the step of shaping the buoyant material to a desired shape.

In another preferred embodiment of the invention, the side walls are positioned such that the body when formed includes a deck having a skirt portion.

In another preferred embodiment of the invention, the method further comprises the step of pouring the concrete such that the body when formed has a relatively low center of gravity.

In another preferred embodiment of the invention, the method utilizes a light weight concrete.

In another preferred embodiment of the invention, the method further comprises the step of painting the aquatic deck structure to give the structure a desired appearance.

Other embodiments and advantages of the invention will be apparent from the following description, the accompanying, drawings, and the appended claims.

### BRIEF DESCRIPTION OF THE DRAWINGS

To provide a more complete understanding of the present invention and further features and advantages thereof, reference is now made to the following description taken in conjunction with the accompanying drawings, in which:

FIG. 1 is a perspective view of an aquarium illustrating a preferred embodiment of the aquatic deck structure of the subject application shown floating along the surface of the water;

FIG. 2 is a cross-sectional view of the aquatic deck structure of FIG. 1 showing a body comprising an inner core formed from a buoyant material encased within an outer wall formed from concrete;

FIG. 3 is a side view showing the step of buoyant material being placed onto a base board for forming the aquatic deck structure of the subject application;

FIG. 4 is a top view showing the step of placing side boards onto the base board such that the side boards are placed a desired distance away from the buoyant material;

FIG. 5 is a side view showing the step of placing side boards onto the base board for forming the aquatic deck structure of the subject application;

FIG. 6 is a side view showing the step of applying a non-stick material to the base board for forming the aquatic deck structure of the subject application;

FIG. 7 is a side view showing the step of placing the buoyant material onto the surface of the wet concrete forming the bottom or deck portion of the aquatic deck structure;

FIG. 8 is a side view showing the step of covering the buoyant material forming the inner core of the aquatic deck structure with a layer of concrete;

FIG. 9 is a perspective view of another preferred embodiment of the aquatic deck structure of the subject application showing the deck having a skirt portion such that it is positioned at or below the surface of the water; and

FIG. 10 is a side view of another preferred embodiment of the aquatic deck structure of the subject application showing an anchoring means for securing the structure in place on the surface of the water.

### DETAILED DESCRIPTION OF THE INVENTION

The present invention relates to aquariums and more particularly to an aquatic deck structure for use in aquariums. The application however, is not intended to be limited by the specific terms so selected, and it is to be understood that each specific term includes all technical equivalents that operate in a similar manner to accomplish a similar purpose.

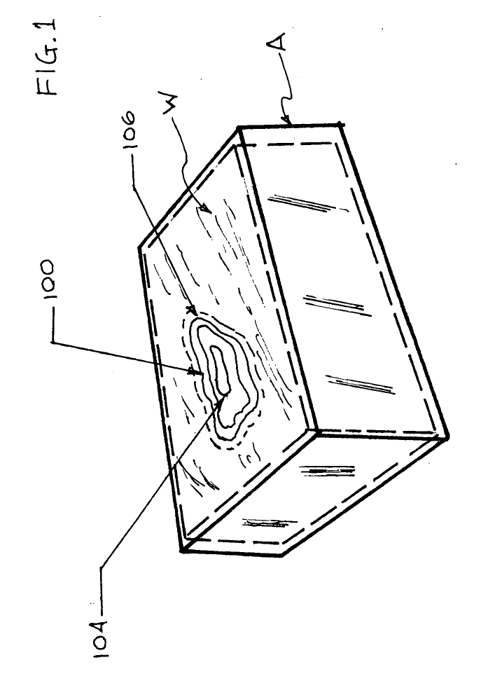

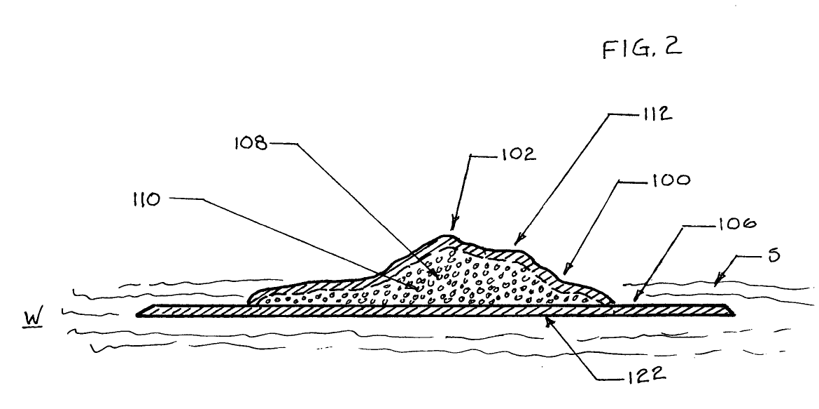

Referring to FIGS. 1 and 2, an aquarium A is shown containing water W therein. The aquatic deck structure 100 of the subject application is effective for floating along the surface S of the water W and comprises a buoyant body 102 having a upper portion 104 and a deck 106. As illustrated in FIG. 2, the buoyant body 102 comprises an inner core 108 formed from a buoyant material 110 encased within an outer wall 112 formed from concrete or other similar material. The buoyant material 110 is preferably a water resistant buoyant material such as polystyrene, cork, wood, air-filled plastic capsules, or other low specific gravity material. The outer wall 112 is preferably formed from a lightweight concrete such as sold under the trademark CONLITE manufactured by Sakrete. It should be understood that other high quality and lightweight concretes having different densities can be used to give the aquatic deck structure 100 the desired buoyancy and floatation characteristics.

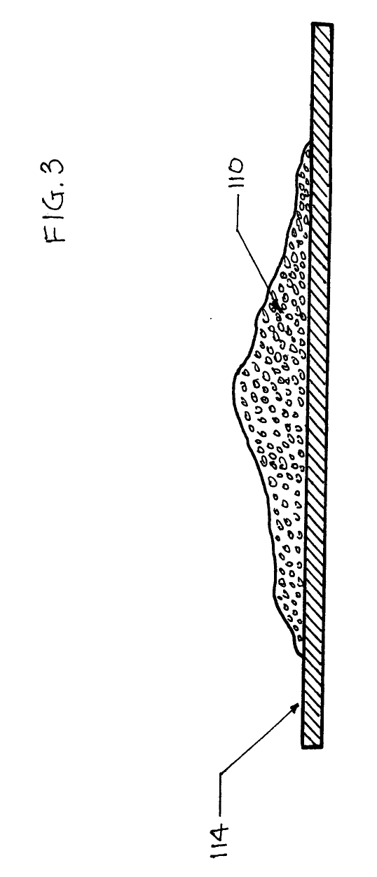

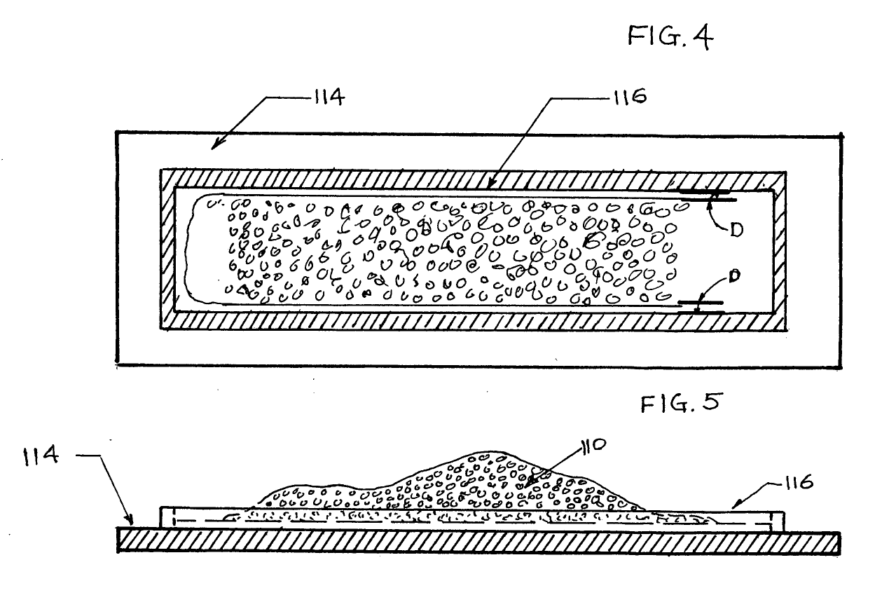

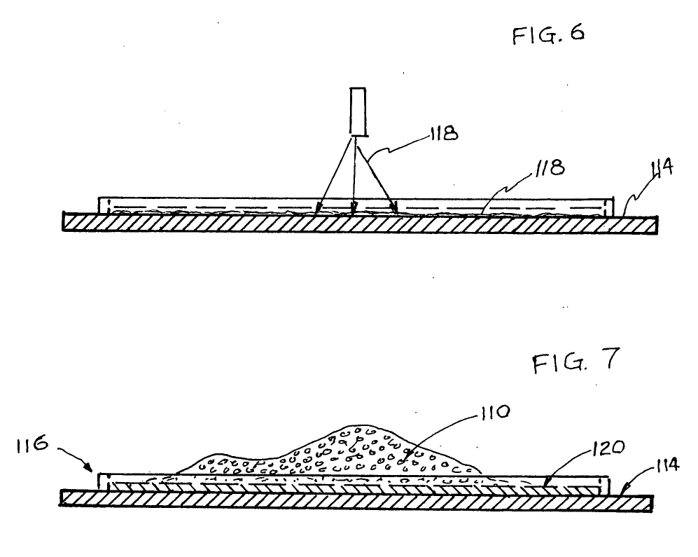

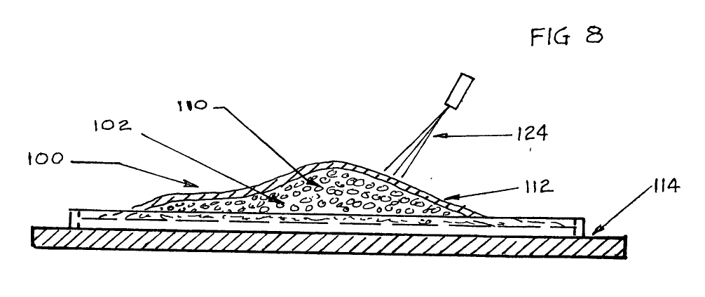

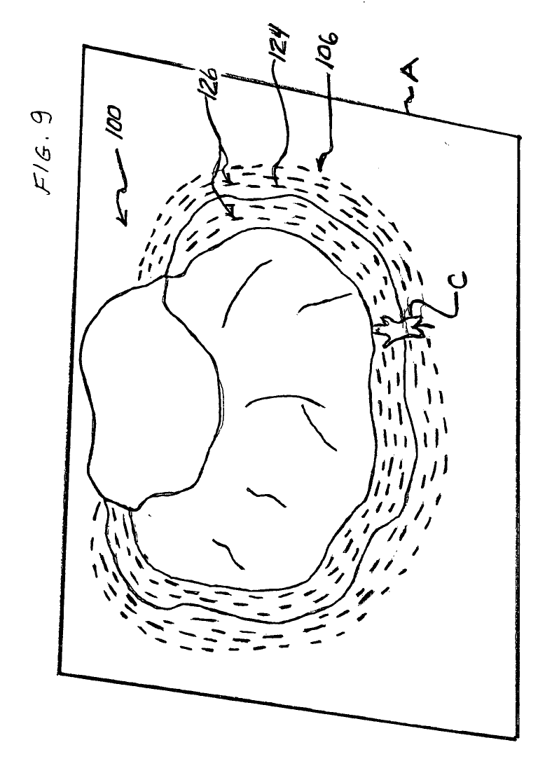

In a preferred embodiment of the invention, the buoyant body 102 is formed by placing the buoyant material 110 forming the inner core 108 onto a base board 114, such as a fiber board (FIG. 3). The buoyant material 110 is then shaped into a desired configuration. For example, the shape can be such that it resembles an island, a rock or log formation, leaves, floating plant life, or any other desirable shape. It should be understood that the aquatic deck structure 100 is constructed and the amount, type, and configuration of the buoyant material 110 is such that the structure it displaces sufficient water to float in water. Side boards 116, such as wood side boards, are then placed onto the base board 114 (FIGS. 4 and 5). The side boards 116 are placed at a distance D away from the buoyant material 110, the distance being the desired thickness of the outer wall 112 forming the aquatic deck structure 100. It should be understood that the side boards 116 may form a rectangular shape base, such as shown. However, the side boards 116 may be constructed to any geometric shape, or may be curved to form a more natural shape. The buoyant material 110 is then removed and the top surface of the base board 114 is coated with a layer of a non-stick material 118, such as a vegetable oil or other material effective for keeping wet concrete from adhering to the base board 114 (FIG. 6). After the non-stick material has been applied to the base board 114, a concrete material 120 is poured onto the base board 114 (FIG. 7) no more than to the height of the side boards 116 to form the bottom 122 and deck 106 (FIG. 2) of the aquatic deck structure 100. The buoyant material 110 is then placed onto the wet concrete (FIG. 7) and covered to a desired thickness with concrete 124 (FIG. 8) to encase the buoyant material 110 within an outer wall 112 to form the aquatic deck structure 100. The thickness of the outer wall 112 is dependent on the density of the concrete being used, the type and configuration of the buoyant material 110 forming the inner core 102, and the desired amount of floatation and stability of the aquatic deck structure 100. It has been found that utilizing this process produces an aquatic deck structure having a configuration with a relatively low center of gravity thus resulting in a structure having good floatation and stability characteristics. It has also been found that the use of the non-stick material, in addition to preventing the wet concrete from adhering to the base board 114, results in the surface of the bottom 122 (FIG. 2) of the aquatic deck structure 100 having a natural rough or textured appearance. The aquatic deck structure 100 can then be painted as desired.

Referring to FIG. 2, the outer wall 112 may be formed to have an increased thickness along or near the deck 106 to effectively lower the center of gravity of the structure 100 thereby improving the stability of the aquatic deck structure 100. It should also be understood that the size, thickness or density of the core 102 and/or the outer wall 112 may be selected to increase the buoyancy and/or the floatation characteristics of the floatable deck structure 100. It should also be understood that by modifying the geometry of the deck 106 the flotation level of the floatable deck structure 100 may also be varied.

Referring to FIGS. 1, 2, and 9, the aquatic deck structure 100 is shown positioned within an aquarium A. As shown, the aquatic deck structure 100 floats along the surface S of the water W such that a skirt portion 124 forming the outer edge of the deck 106 of the body 102 is at or below the surface S of the water W. The skirt portion 124 is effective for permitting marine creatures C to easily climb onto the aquatic deck structure 100. The skirt portion 124 is also suitably sized such that a marine creature C can rest while a portion of its body remains covered or partially covered with water W. It should also be understood that the concrete selected for forming the deck 106 may be such that it produces a surface that is sufficiently coarse to increase climbing traction, in order to further facilitate a marine creature's C ability to climb onto the aquatic deck structure 100, all or a portion of deck 106 and/or the skirt portion 124 may be provided with ridges 126 for providing extra traction for climbing.

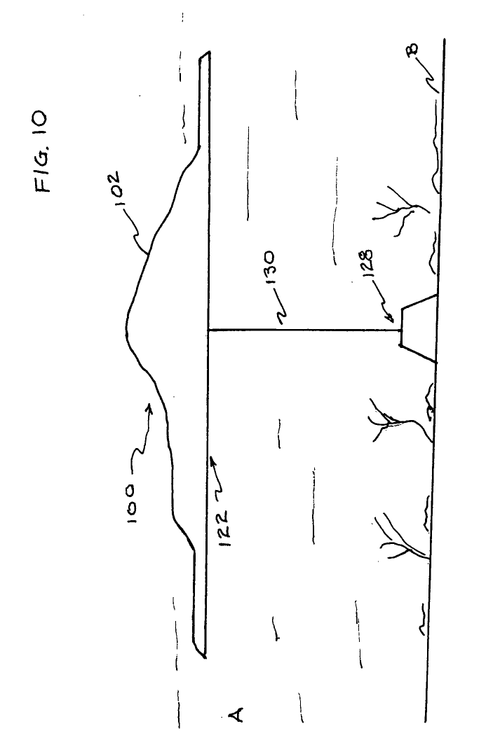

Referring to FIG. 10, in another preferred embodiment of the invention, the aquatic deck structure 100 further comprises an anchoring means 128 that can be attached to the bottom 122, as shown, or side of the body 102 by a line 130 so that the anchoring means 128 is resting on the bottom B of the aquarium A, as shown, or attached to a static structure, not shown, such that the aquatic deck structure 100 will not drift out of position in the aquarium A.

It should now be apparent to those skilled in the art that the aquatic deck structure for use in an aquarium provides a deck for permitting marine creatures to easily climb completely or partially out of the water, is relatively buoyant and stable in water, can be used effectively for both large and small aquariums, and enhances the scenic appearance within the aquarium. It should also now be apparent to those skilled in the art that the aquatic deck structure of the subject application is relatively inexpensive and easy to manufacture.

I claim:

1. An aquatic deck structure for floating along the surface of water contained within an aquarium, the aquatic deck structure comprising:
a body having an inner core formed from a buoyant material encased within an outer wall formed from concrete;
wherein said body having a deck and a contour such that at least a portion of said deck is at or below the surface of the water.

2. The aquatic deck structure of claim 1 wherein said structure has a shape that simulates the appearance of an island.

3. The aquatic deck structure of claim 1 wherein said structure has a shape that simulates a natural aquatic structure.

4. The aquatic deck structure of claim 3 wherein said natural aquatic structure is selected from the list consisting of rock formations, log formations, leaves, an island formation, and water plants.

5. The aquatic deck structure of claim 1 wherein said deck includes ridges to improve traction.

6. The aquatic deck structure of claim 1 wherein said body is weighted to allow a portion of said deck to be maintained at or below the level of the water.

7. The aquatic deck structure of claim 1 wherein said buoyant material is selected from materials consisting of polystyrene, cork, wood, and air-filled plastic capsules.

8. The aquatic deck structure of claim 6 wherein said deck includes a skirt portion effective for supporting a marine creature and permitting the marine creature to be covered by water.

9. The aquatic deck structure of claim 1 further comprising anchoring means for securing the structure in place on the surface of the water.

10. An aquatic deck structure for floating along the surface of water contained within an aquarium, the aquatic deck structure comprising:
a body having an inner core formed from a buoyant material encased within an outer wall formed from concrete, said body further comprising a deck having a skirt portion;
wherein said skirt portion is effective for supporting at least one marine creature and permitting a portion of the marine creature to be covered by water.

11. The aquatic deck structure of claim 10 wherein said body is weighted to produce a low center of gravity.

12. The aquatic deck structure of claim 10 further comprising anchoring means for securing the structure in place on the surface of the water.

13. A method of manufacturing an aquatic deck structure comprising the steps of:
coating a base board with a non-stick material;
placing side boards onto the base board; and
forming a body by pouring concrete onto the base board to a desired thickness;
placing a buoyant material onto the base board; and
pouring concrete over the buoyant material encase the buoyant material within an outer wall of a desired thickness.

14. The method of claim 13 further comprising the step of shaping the buoyant material to a desired shape.

15. The method of claim 13 wherein the side walls are positioned such that the body when formed includes a deck having a skirt portion.

16. The method of claim 13 wherein the concrete is poured such that the body when formed has a relatively low center of gravity.

17. The method of claim 13 wherein the concrete is a light weight concrete.

18. The method of claim 13 further comprising the step of painting the aquatic deck structure to give the structure a desired appearance.
